(19) United States
(12) Patent Application Publication
(10) Pub. No.: US 2012/0128933 A1
(43) Pub. Date: May 24, 2012

(54) ANTICORROSION LAYER AND MANUFACTURING METHOD THEREOF

(75) Inventors: Jui-Ming Yeh, Taoyuan County (TW); Cheng-Jian Weng, Taoyuan County (TW); Chih-Wei Peng, Taipei County (TW); Chi-Hao Chang, Pingtung County (TW)

(73) Assignee: CHUNG-YUAN CHRISTIAN UNIVERSITY, Jhong-Li City (TW)

(21) Appl. No.: 12/951,133

(22) Filed: Nov. 22, 2010

(51) Int. Cl. B32B 15/08; B32B 5/16; B32B 33/00; B29C 35/08

(52) U.S. Cl. 428/143; 427/595; 428/141

(57) ABSTRACT

The present invention relates to an anticorrosion layer and a manufacturing method thereof, wherein the anticorrosion layer is capable of being coated onto the surface of a substrate for preventing the substrate surface from corrosion, the anticorrosion layer comprises: a polymer material layer, coated on the substrate surface; and a continuous rough surface layer, formed on the surface of the polymer material layer, wherein the continuous rough surface layer has a surface roughness great than 10 nm. Moreover, through the manufacturing method, a protective layer (the anticorrosion layer) with excellent anticorrosion efficiency and low pollution property can be rapidly and massively formed on the substrate surface by way of using a replica mold.

### BACKGROUND OF THE INVENTION

1. Technical Field

The present invention relates to an anticorrosion layer capable of being coated on the surface of a metal substrate for preventing the metal surface from corrosion, and more particularly, to an anticorrosion layer having a surface roughness grater than 10 nm and a manufacturing method thereof.

2. Description of Related Art

For the currently conventional industrial technology, it is able to extend the life time of a metal by executing surface processes on the metal surface and changing the properties thereof. There are many surface processing methods in the conventional industrial technology, such as: chemical conversion, rust preventive treatment, thermal spray, lining, electroplate, cathodic protection, etc. So that, by using the surface processing methods, a protective film can be formed on the metal surface, so as to increase the anticorrosion (anti-oxidation) ability of the metal surface.

Generally, the protective film is divided to inorganic films and organic films, wherein the inorganic film includes: metal film, glass film, ceramics film, and conversion film made by way of anodic treatment or phosphorylation process. The organic film includes: paint, resin, paraffin, ointment, rubber, and asphalt. Each of protective films has the self properties and the usage scopes thereof, for instance, the ceramics film has good heat and acid resistance but is friable; the alumina and the magnesia obtained by the anodic treatment are dense and protective; the asphalt is inexpensive and has good corrosion resistance but its appearance color is black and looks not good.

However, considering to the processing cost, the metal film and the organic paint are the most important protective films. In the current industrial technology, the processing method (technology) of the metal film consists of: electroplating, electroless plating, hot dip, vacuum deposition, and cathodic sputtering. The organic paint consists of resin, paint and auxiliary agent, and the way to apply the organic paint includes: painting, air spray, aerosol, electropaint, electrostatic paint, and powder coating. However, the pigments and the pretreatment agents in the applying way of the organic pint both consist of heavy metal compounds with lead and hexavalent chromium, such as: Pb₃O₄, ZnCrO₄, SrCrO₄, or CaPbO₃. These substances are proven carcinogens and trigger sources of the pollution diseases, for example, Pb₃O₄ and ZnCrO₄ cause lung cancer, gastric cancer and heavy metal pollution. For this reason, advanced countries are getting to legislate for prohibiting the use of those substances.

Thus, according to the above description, it is able to know that, there are many processing method for fabricating the protective film on the metal surface in the conventional industrial technology; however, the pigments and the pretreatment agents in the processing method of the protective film both consist of heavy metal compounds with lead and hexavalent chromium, which substances will cause lung cancer, gastric cancer and heavy metal pollution.

Accordingly, in view of the conventional protective films and the processing method thereof have shortcomings and drawbacks, the inventor of the present application has made great efforts to make inventive research thereon and eventually provided an anticorrosion layer and a manufacturing method thereof.

### BRIEF SUMMARY OF THE INVENTION

The primary objective of the present invention is to provide an anticorrosion layer, in which a protective layer with low pollution and high anticorrosion efficiency is formed on the surface of a substrate by way of coating a polymer material layer on the substrate surface and forming a continuous rough surface layer with a surface roughness greater than 10 nm on the polymer material layer surface, so as to protect the substrate surface from corrosion.

The another objective of the present invention is to provide a method for manufacturing an anticorrosion layer, in which a replica mold is utilize to rapidly and massively fabricate the anticorrosion layers on the surfaces of substrates for avoiding the substrate surfaces from corrosion.

Accordingly, to achieve the abovementioned primary objective, the inventor proposes an anticorrosion layer, capable of being coated onto the surface of a substrate and comprises: a polymer material layer, coated on the surface of the substrate; and a continuous rough surface layer, formed on the surface of the polymer material layer and having a surface roughness.

Moreover, to achieve the another objective, the inventor proposes a method for manufacturing a anticorrosion layer, comprising the steps of: (1) fabricating a polymer mixture; (2) manufacturing a replica mold by using the polymer mixture; (3) making a polymer material coating solution; (4) coating the polymer material coating solution onto the surface of a metal substrate; (5) disposing the replica mold on the surface of the metal substrate; (6) using an optical light with short wavelength to expose the metal substrate; (7) waiting for the solidification of the polymer material coating solution; and (8) removing the replica mold from the surface of the metal substrate.

### BRIEF DESCRIPTION OF THE SEVERAL VIEWS OF THE DRAWINGS

The invention as well as a preferred mode of use and advantages thereof will be best understood by referring to the following detailed description of an illustrative embodiment in conjunction with the accompanying drawings, wherein:

FIG. 1 is a schematic diagram of an anticorrosion layer according to the present invention;

FIG. 2 is a flow chart of a method for manufacturing the anticorrosion layer according to the present invention;

FIG. 3 is a detailed flow chart of step (201);

FIG. 4 is the detailed flow chart of step (202);

FIG. 5 is the detailed flow chart of step (203);

FIG. 6 is the schematic diagram of a first control anticorrosion layer;

FIG. 7 is an SEM photo-image of the first control anticorrosion layer;

FIG. 8 is the SEM photo-image of the anticorrosion layer of the present invention;

FIG. 9 is a Tafel curve plot of a metal substrate surface;

FIG. 10 is the flow chart of a second method for manufacturing the anticorrosion layer according to the present invention;

FIG. 11 is the detailed flow chart of step (210);

FIG. 12is the detailed flow chart of step (211);

FIG. 13 is the SEM photo-image of a second control anticorrosion layer;

FIG. 14 is the SEM photo-image of a second anticorrosion layer of the present invention;

FIG. 15 is the Tafel curve plot of the metal substrate surface; and

FIG. 16 is a data table of the measuring data of all anticorrosion layers.

### DETAILED DESCRIPTION OF THE INVENTION

To more clearly describe an anticorrosion layer and a manufacturing method thereof according to the present invention, embodiments of the present invention will be described in detail with reference to the attached drawings hereinafter.

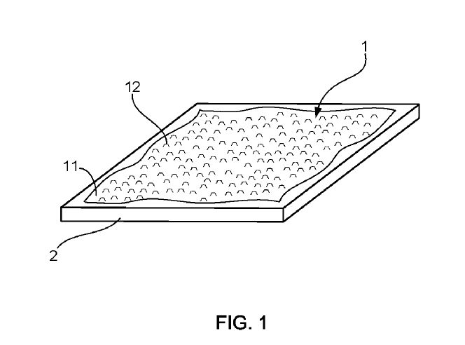

With reference to FIG. 1, a schematic diagram of an anticorrosion layer according to the present invention is illustrated. As shown in FIG. 1, an anticorrosion layer 1 is able to be coated on the surface of a substrate 2 and includes: a polymer material layer 11 and a continuous rough surface layer 12. The polymer material layer 11 is coated on the surface of the substrate 2, and the continuous rough surface layer 12 is formed on the surface of the polymer material layer 11 and having a surface roughness ranging from 5 nm to 10 um; Moreover, preferably, the best range of the surface roughness is from 10 nm to 10 um. Besides, the anticorrosion layer 1 has a water contact angle ranging from 90° to 180°, and preferably, when the water contact angle ranges from 120° to 160°, the anticorrosion layer 1 performs a perfect hydrophobicity and is able to effectively block external corrosion factors, such as water or chloride ion; so that, the corrosion factors can not pass through the anticorrosion layer 1 to contact the surface of the metal substrate 2.

In terms of the manufacture, the fabricating material of the polymer material layer 11 consists of: an epoxy, a polyimide, a polyaniline, a polyurethane, a polyethylene, a polyvinylchloride (PVC), a nylon, an Acrylonitrile Butadiene Styrene (ABS) plastic resin, a polystyrene, a polymethylmethacrylate (PMMA), a Teflon, a polycarbonate, a polylactide, and a compound made of any two materials listed above; Besides, the way to form the plurality of continuous protuberances on the polymer material layer 11 consists of: photolithography process, inorganic particles stacking technology, chemical vapor deposition (CVD), physical vapor deposition (PVD), surface plasma process, replica molding method, electrochemical deposition, phase separation method, and electrospinning Furthermore, when forming the plurality of continuous protuberances, the dimension of the surface roughness of the continuous rough surface layer 12 is controlled and chosen.

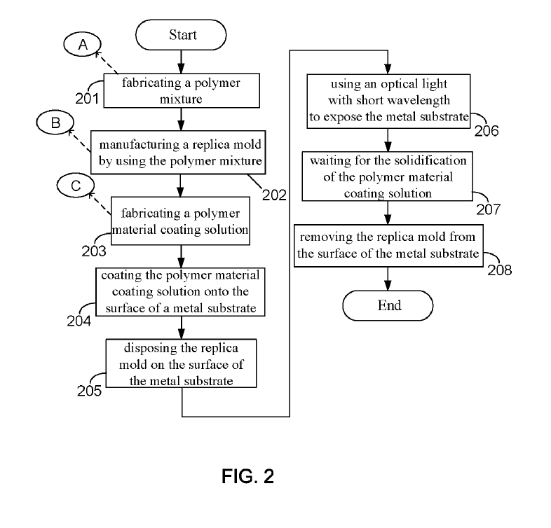

Thus, the materials and the composition of the anticorrosion layer 1 of the present invention are clearly disclosed; after that, a method for manufacturing the anticorrosion layer will consecutively be disclosed. Please refer to FIG. 2, which illustrates a flow chart of the method for manufacturing the anticorrosion layer according to the present invention, as shown in FIG. 2, the method for manufacturing the anticorrosion layer includes the steps of:

Firstly, proceeding to step (201), fabricating a polymer mixture; Next proceeding to step (202), manufacturing a replica mold by using the polymer mixture; Then, proceeding to step (203), making a polymer material coating solution, wherein the polymer material coating solution is the liquid state of the polymer material layer 11. After the step (203) is completed, proceeding to step (204), coating the polymer material coating solution onto the surface of a metal substrate; Next proceeding to step (205), disposing the replica mold on the surface of the metal substrate; Then, proceeding to step (206), using an optical light with short wavelength to expose the metal substrate, and consecutively proceeding to step (207), waiting for the solidification of the polymer material coating solution; Finally, proceeding to step (208), removing the replica mold from the surface of the metal substrate. So that, as shown in FIG. 1, the anticorrosion layer 1 is formed on the surface of the metal substrate 2 by finishing the steps from (201) to (208).

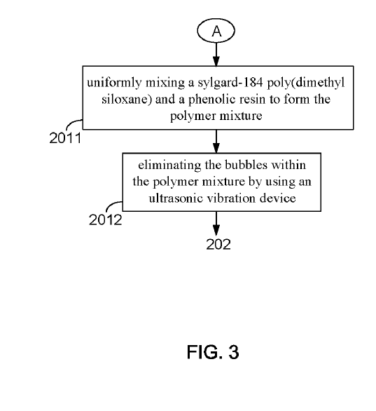

Moreover, for more detailed disclosing the manufacturing method, please refer to FIG. 3, which illustrates a detailed flow chart of the step (201). In the above-mentioned method for manufacturing the anticorrosion layer, the step (201) further includes the detailed steps of:

Firstly, proceeding to step (2011), uniformly mixing a sylgard-184 poly(dimethyl siloxane) and a phenolic resin to form the polymer mixture, and proceeding to step (2012), eliminating the bubbles within the polymer mixture by using an ultrasonic vibration device.

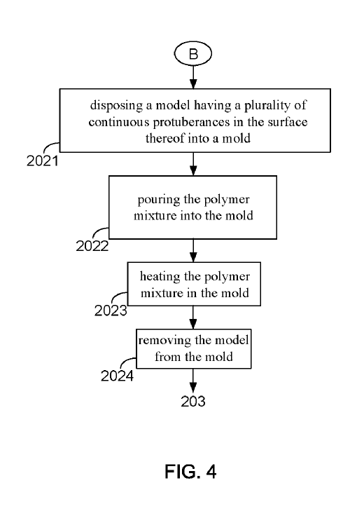

Furthermore, referring to FIG. 4, the detailed flow chart of the step (202) is illustrated. The step (202) of the above-mentioned method for manufacturing the anticorrosion layer further includes the detailed steps of:

Firstly, proceeding to step (2021), disposing a model having a plurality of continuous protuberances in the surface thereof into a mold; Next proceeding to step (2022), pouring the polymer mixture into the mold; Then, proceeding to step (2023), heating the polymer mixture in the mold; Finally, proceeding to step (2024), removing the model from the mold.

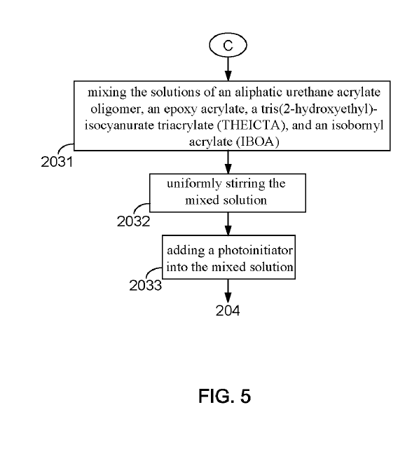

Furthermore, referring to FIG. 5, which illustrates a detailed flow chart of the step (203), the step (203) of the above-mentioned method for manufacturing the anticorrosion layer further includes the detailed steps of:

Firstly, proceeding to step (2031), mixing the solutions of an aliphatic urethane acrylate oligomer, an epoxy acrylate, a tris(2-hydroxyethyl)-isocyanurate triacrylate (THEICTA), and an isobornyl acrylate (IBOA); Next proceeding to step (2032), uniformly stirring the mixed solution; and finally, proceeding to step (2033), adding a photoinitiator into the mixed solution.

Thus, through the FIG. 2, FIG. 3, FIG. 4, and FIG. 5, the complete manufacturing method of the anticorrosion layer according to the present invention has been clearly disclosed; Besides, for proving the practicability of the anticorrosion layer and the manufacturing method thereof according to the present invention, in follows, it will show the experimental data and the photo-images by way of an experimental group and a control group.

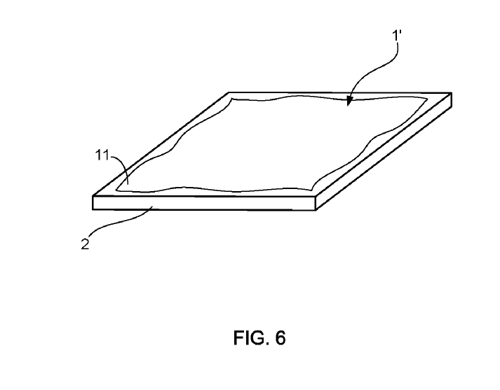

With reference to FIG. 6, which illustrated the schematic diagram of a first control anticorrosion layer. As shown in FIG. 6, after the polymer material layer coating solution is coated on the surface of the metal substrate 1, the polymer material layer 11 is formed on the metal substrate surface, wherein the polymer material layer 11 is a first control anticorrosion layer 1′ without the continuous rough surface layer having the surface roughness.

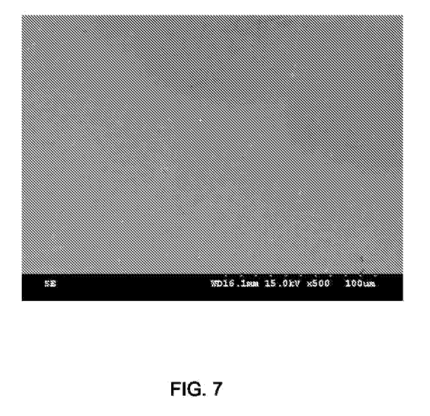

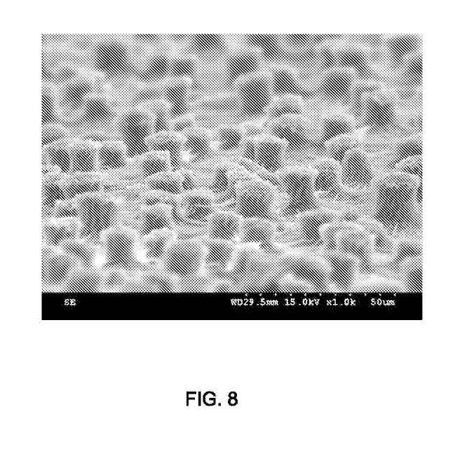

Please refer to FIG. 7, which illustrates an SEM photo-image of the first control anticorrosion layer. Since the first control anticorrosion layer 1′ not includes the continuous rough surface layer, so that, as shown in FIG. 7, the photo-image of the surface of the first control anticorrosion layer 1′ got by using a scanning electron microscope (SEM) is a nearly flat surface. Moreover, referring to FIG. 8, the SEM photo-image of the anticorrosion layer of the present invention is illustrated. In FIG. 8, the anticorrosion layer 1 of the present invention is made of the polymer material layer 11 and the continuous rough surface layer 12, therefore, the photo-image of the anticorrosion layer surface obtained through the scanning electron microscope obviously shows the plurality of continuous protuberances and has a certain surface roughness.

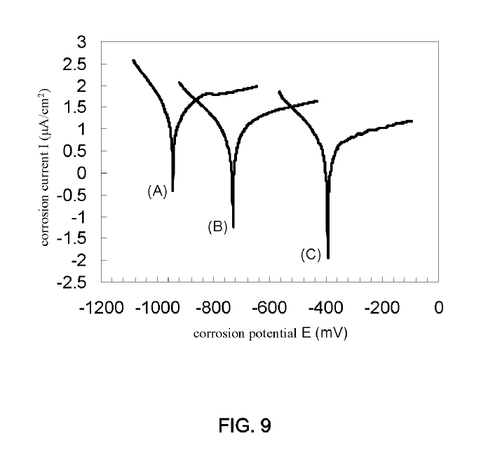

In addition, for evaluating the anticorrosion efficiencies of the anticorrosion layer 1 and the first control anticorrosion layer 1′, the Tafel curves of the two layers are plotted after finishing the electrochemical measurements. Referring to FIG. 9, which illustrates the Tafel curves plot of the metal substrate surface. As shown in FIG. 9, the horizontal axis is the coordinates of a corrosion potential (E), the vertical axis is the coordinates of a corrosion current (I), the curve (A) is the Tafel curve of the surface of the metal substrate 2, the curve (B) is the Tafel curve of the surface of first control anticorrosion layer 1′, and the curve (C) is the Tafel curve of the surface of the anticorrosion layer 1. Generally, if the Tafel curve of one surface (material layer) shows high corrosion potential but low corrosion current, the surface (material layer) performs a great anticorrosion efficiency. Thus, to compare the curve (A), the curve (B) and the curve (C) under this criterion, it is easily to know that the anticorrosion layer 1 has the excellent anticorrosion efficiency than first control anticorrosion layer 1′.

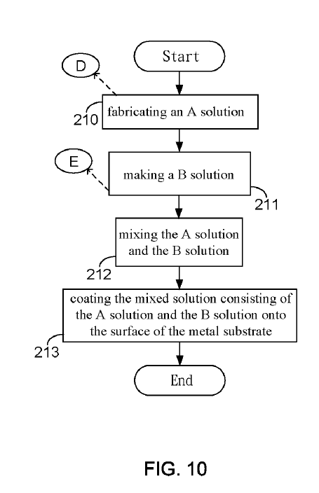

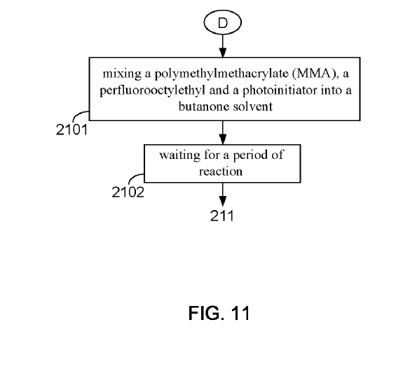

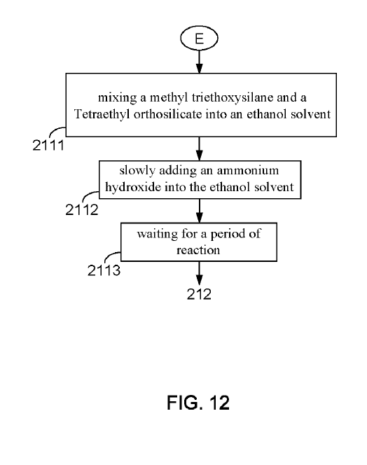

Furthermore, it further includes a second method for manufacturing the anticorrosion layer according to the present invention. Please refer to FIG. 10, the flow chart of the second method for manufacturing the anticorrosion layer is illustrated; and simultaneously, referring to FIG. 11 and FIG. 12, which respectively illustrate the detailed flow charts of step (210) and step (211), the second method for manufacturing the anticorrosion layer includes the steps of:

Firstly, proceeding to step (210), fabricating an A solution. The step (210) includes two detailed steps of: step (2101), mixing a polymethylmethacrylate (MMA), a perfluorooctylethyl and a photoinitiator into a butanone solvent; and step (2102), waiting for a period of reaction; So that, the A solution has been finished after completing the step (2101) and the step (2102).

After step (210) is finished, proceeding to step (211), making a B solution. As shown in FIG. 12, the step (211) includes three detailed steps of: step (2111), mixing a methyl triethoxysilane and a Tetraethyl orthosilicate into an ethanol solvent; step (2112), slowly adding an ammonium hydroxide into the ethanol solvent; and step (2113), waiting for a period of reaction. Thus, the B solution has been finished after completing step (2111), step (2112) and step (2113).

Continuously referring to FIG. 10, after the step (211) is finished, the manufacturing flow is proceeded to step (212), mixing the A solution and the B solution and getting a mixed solution; Then, proceeding to step (213), coating the mixed solution consisting of the A solution and the B solution onto the surface of the metal substrate. Thus, a second anticorrosion layer with a continuous rough surface is formed on the metal substrate surface after the mixed solution becomes solidification.

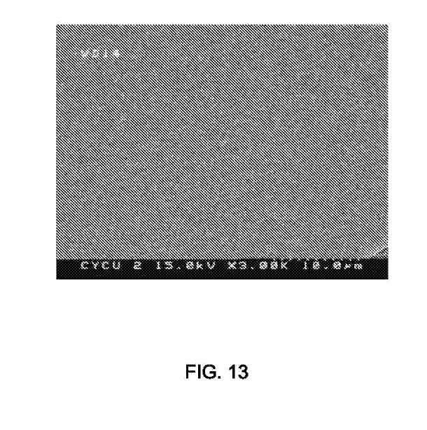

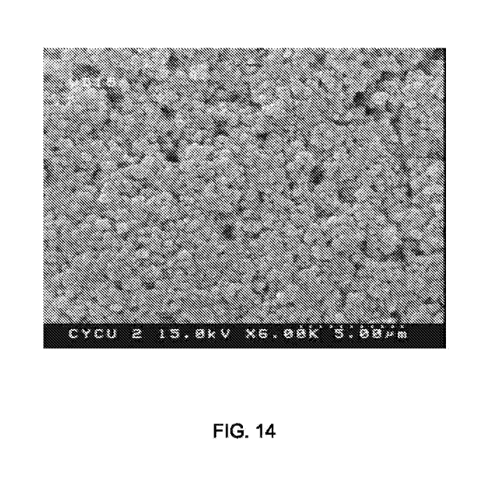

Similarly, for evaluating the anticorrosion efficiencies of the anticorrosion layer made by the second manufacturing method described above, the A solution is directly coated onto the metal substrate surface, so as to form a second control anticorrosion layer. Please refer to FIG. 13, the SEM photo-image of a second control anticorrosion layer is illustrated. To compare FIG. 13 with FIG. 7, the second control anticorrosion layer shows extremely fine continuous rough surface than the first control anticorrosion layer's. Besides, please refer to FIG. 14, the SEM photo-image of the second anticorrosion layer of the present invention is illustrated. Thus, comparing FIG. 14 with FIG .13, the continuous rough surface of the second anticorrosion layer performs a great surface roughness than the continuous rough surface of the second control anticorrosion layer.

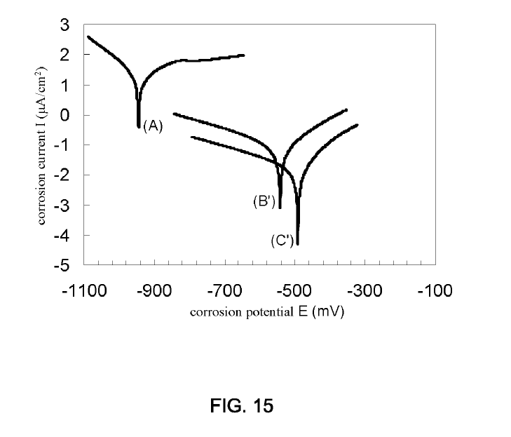

Moreover, for evaluating the anticorrosion efficiencies of the second anticorrosion layer and the second control anticorrosion layer, the Tafel curves of the two layers are plotted after finishing the electrochemical measurements. Referring to FIG. 15, which illustrates a second Tafel curves plot of the metal substrate surface. In FIG. 15, the horizontal axis is the coordinates of the corrosion potential (E), the vertical axis is the coordinates of the corrosion current (I), the curve (A′) is the Tafel curve of the surface of the metal substrate, the curve (B′) is the Tafel curve of the surface of second control anticorrosion layer, and the curve (C′) is the Tafel curve of the surface of the second anticorrosion layer. Thus, to compare the curve (A′), the curve (B′) and the curve (C′) each other, it is easily to know that the second anticorrosion layer has the excellent anticorrosion efficiency than second control anticorrosion layer.

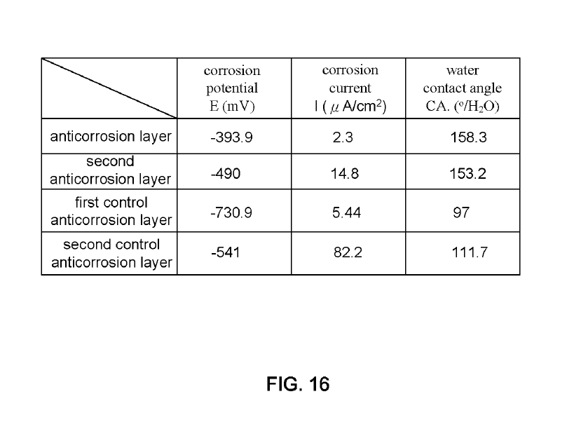

Furthermore, please refer to FIG. 16, which illustrate a data table of the measuring data of all anticorrosion layers. In the data table shown in FIG. 16, it is able to know that the corrosion potential, the corrosion current and the water contact angle of the anticorrosion layer 1 of the present invention are −393.9 mV, 2.3 μA/cm² and 158.3°/H₂O, respectively; the corrosion potential, the corrosion current and the water contact angle of the second anticorrosion layer of the present invention are −490 mV, 14.8 μA/cm² and 153.2°/H₂O, respectively; the corrosion potential, the corrosion current and the water contact angle of the first control anticorrosion layer are −730.9 mV, 5.44 μA/cm² and 97°/H₂O, respectively; and the corrosion potential, the corrosion current and the water contact angle of the second control anticorrosion layer are −541 mV, 82.2 μA/cm² and 111.7°/H₂O, respectively. So that, through above data table, it has confidence in the anticorrosion layer of the present invention made by using the manufacturing method described above is able to provide an excellent anticorrosion efficiency to the metal substrate surface.

Thus, the anticorrosion layer and the manufacturing method thereof according to the present invention have been disclosed completely and clearly in the above description. In summary, the present invention has the following advantages:
1. The main material layer of the anticorrosion layer is the polymer material layer, so that, through forming the continuous rough surface layer with the surface roughness greater than 10 nm on the polymer material layer, the anticorrosion layer is able to perform the excellent anticorrosion efficiency and low pollution property.
2. Distinguishing from the powder coating or the electropaint used in the conventional surface processing technology; however, in the present invention, the corrosion layer is made by using the replica mold to rapidly and massively fabricate on the surfaces of substrates without any other processes.
3. Inheriting to above point 2, in addition to the method of using the replica mold, the way to form the plurality of continuous protuberances on the polymer material layer consists of: photolithography process, inorganic particles stacking technology, chemical vapor deposition (CVD), physical vapor deposition (PVD), surface plasma process, replica molding method, electrochemical deposition, phase separation method, and electrospinning

The above description is made on embodiments of the present invention. However, the embodiments are not intended to limit scope of the present invention, and all equivalent implementations or alterations within the spirit of the present invention still fall within the scope of the present invention.

We claim:

1. An anticorrosion layer, capable of being coated onto the surface of a substrate, comprising:
a polymer material layer, being coated on the surface of the substrate; and
a continuous rough surface layer, being formed on the surface of the polymer material layer and having a surface roughness.

2. The anticorrosion layer of claim 1, wherein the polymer material layer is selected from the group consisting of: an epoxy, a polyimide, a polyaniline, a polyurethane, a polyethylene, a polyvinylchloride (PVC), a nylon, an Acrylonitrile Butadiene Styrene plastic resin (ABS resin), a polystyrene, a polymethylmethacrylate (PMMA), a Teflon, a polycarbonate, a polylactide, and a compound made of any two materials listed above.

3. The anticorrosion layer of claim 1, wherein the surface roughness comprises a plurality of continuous protuberances.

4. The anticorrosion layer of claim 3, wherein the way to make the plurality of continuous protuberances is selected from the group consisting of: photolithography process, inorganic particles stacking technology, chemical vapor deposition (CVD), physical vapor deposition (PVD), surface plasma process, replica molding method, electrochemical deposition, phase separation method, and electrospinning

5. The anticorrosion layer of claim 1, comprising a water contact angle ranging from 90° to 180°.

6. The anticorrosion layer of claim 1, wherein the surface roughness of the continuous rough surface layer ranges from 5 nm to 10 um.

7. The anticorrosion layer of claim 1, wherein the substrate is a metal substrate.

8. A method for manufacturing a anticorrosion layer, comprising the steps of:
(1) fabricating a polymer mixture;
(2) manufacturing a replica mold by using the polymer mixture;
(3) making a polymer material coating solution;
(4) coating the polymer material coating solution onto the surface of a metal substrate;
(5) disposing the replica mold on the surface of the metal substrate;
(6) using an optical light with short wavelength to expose the metal substrate;
(7) waiting for the solidification of the polymer material coating solution; and
(8) removing the replica mold from the surface of the metal substrate.

9. The method for manufacturing the anticorrosion layer of claim 8, wherein the step (1) further comprises the steps of:
(11) uniformly mixing a sylgard-184 poly(dimethyl siloxane) and a phenolic resin to form the polymer mixture; and
(12) eliminating the bubbles within the polymer mixture by using an ultrasonic vibration device.

10. The method for manufacturing the anticorrosion layer of claim 8, wherein the step (2) further comprises the steps of:
(21) disposing a model having a plurality of continuous protuberances in the surface thereof into a mold;
(22) pouring the polymer mixture into the mold;
(23) heating the polymer mixture in the mold; and
(24) removing the model from the mold.

11. The method for manufacturing the anticorrosion layer of claim 8, wherein the step (3) further comprises the steps of:
(31) mixing the solutions of an aliphatic urethane acrylate oligomer, an epoxy acrylate, a tris(2-hydroxyethyl)-isocyanurate triacrylate (THEICTA), and an isobornyl acrylate (IBOA);
(32) uniformly stirring the mixed solution; and
(33) adding a photoinitiator into the mixed solution.
